(19) United States
(12) Patent Application Publication
(10) Pub. No.: US 2008/0009202 A1
(43) Pub. Date: Jan. 10, 2008

(54) Wire connector and method of fabricating the same

(75) Inventor: Chun Wei Yang, Chang Hwa (TW)

Correspondence Address: REED SMITH LLP, Suite 1400, 3110 Fairview Park Drive, Falls Church, VA, 22042, US

(73) Assignee: K.S. Terminals, Inc.

(21) Appl. No.: 11/522,470

(22) Filed: Sep. 18, 2006

(30) Foreign Application Priority Data
Jul. 5, 2006 (TW) 95124557

(51) Int. Cl. H01R 11/09

(52) U.S. Cl. 439/787

(57) ABSTRACT

This invention relates to a wire connector and method of fabricating the same. The wire connector assembled by an insulating tube and a soldering sleeve is used to connect a plurality of conducting wires which are made of conducting cores and insulating claddings surrounding the conducting cores. The insulating tube with the melting point at the second temperature is shrinking to deform when heated to the first temperature. The soldering sleeve with corrugated surface is placed in the insulating tube. The melting point of the soldering sleeve is the third temperature which is between the first temperature and the second temperature. When heating the external part of the insulating tube where corresponding to the soldering sleeve by the temperature between the first temperature and the third temperature, the insulating tube will shrink to lodge the corrugated surface of the soldering sleeve, and the wire connector is assembled.

### BACKGROUND OF THE INVENTION

1. Field of the Invention

The present invention is related to a wire connector, and more specifically, to a wire connector using an insulating tube and a soldering sleeve as its connective device.

2. The Prior Arts

Conventionally, for connecting a couple of conducting wires, it used to entwine an insulating adhesive tape around two conducting cores stuck out of insulating claddings. However, it would induce the leakage of electricity by humidity. Hence, the U.S. Pat. No. 4,883,925 addressed this problem by heating the main support member constructed of a flexible plastic tubing and a coated adhesive film inside results in initial securing of the wire anchor assembly centrally of the main support member and melting and fusing the wire anchor member to the wire sections of the wire members. However, the adhesive film coated inside the main support member is too expensive and not easy for assembly.

### SUMMARY OF THE INVENTION

For solving the aforementioned problem, this invention provides a wire connector assembled by an insulating tube and a soldering sleeve for connecting a plurality of conducting wires which are made of conducting cores and insulating claddings surrounding the conducting cores. The insulating tube with the melting point at the second temperature is shrinking to deform when heated to the first temperature. The soldering sleeve with corrugated surface is placed in the insulating tube. The melting point of the soldering sleeve is the third temperature which is between the first temperature and the second temperature. When heating the external part of the insulating tube where corresponding to the soldering sleeve by the temperature between the first temperature and the third temperature, the insulating tube will shrink to lodge the corrugated surface of the soldering sleeve, and the wire connector is assembled.

It's therefore an object of this invention to provide a wire connector with better connecting effect.

It's another object of this invention to provide a method of fabricating a wire connector with better connecting effect.

It's yet another object of this invention to providing a soldering sleeve for being placed in the wire connector to result in better connection with the insulating tube.

### BRIEF DESCRIPTION OF THE DRAWINGS

FIG. 1 is the diagram of the wire connector provided by the present invention.

FIG. 2 is the diagram of the wire connector provided by the present invention.

FIG. 3 is the diagram of the soldering sleeve provided by the present invention.

FIG. 4 is the diagram of the soldering sleeve provided by the present invention.

### DETAILED DESCRIPTION OF THE PREFERRED EMBODIMENT

The present invention discloses a structure of a wire connector and the method of fabricating the same. Since some methods of fabrication and combination used within the structure have been disclosed in detail in the prior art, therefore the fabricating process of the wires or the conducting cores and the way of tying a couple of wires are not described in detail in the following description. Moreover, the diagrams included in the following are not completely drawn according to the real size and are only used to demonstrate features related to the present invention.

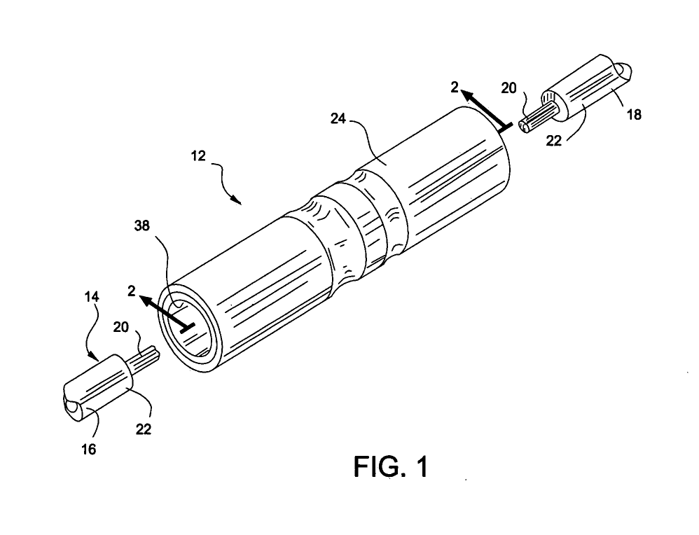

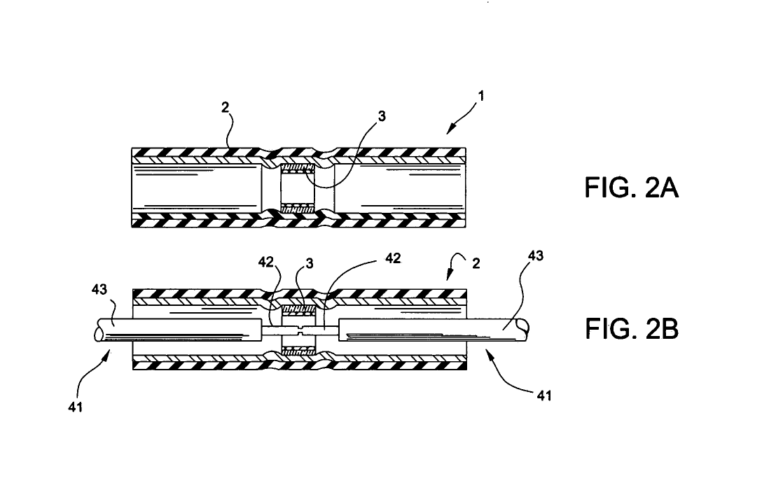

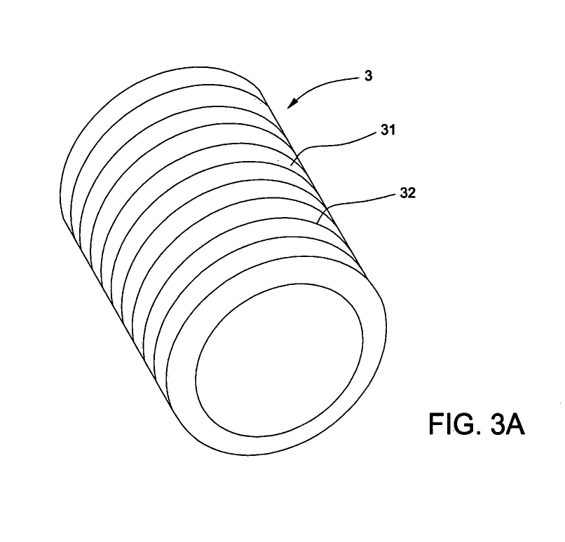

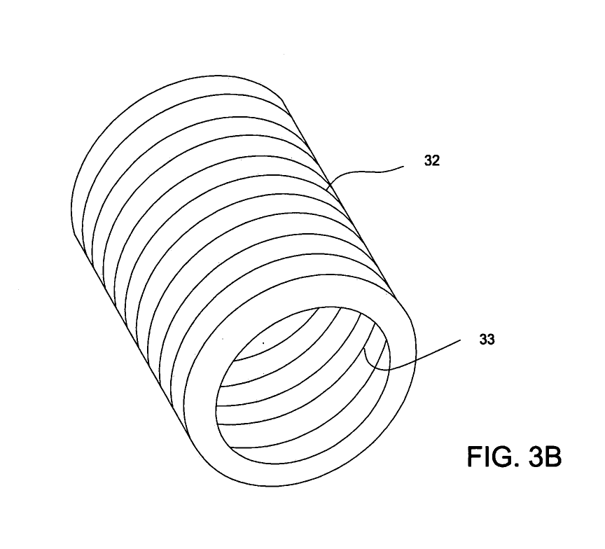

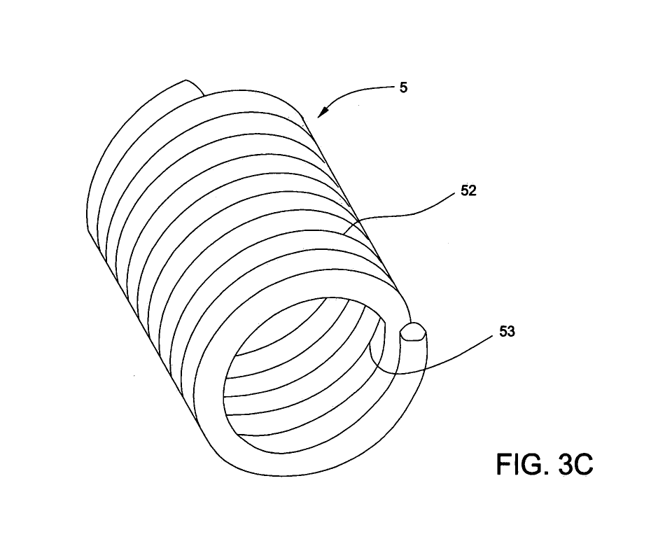

Referring now to FIG. 1 and FIG. 2, they are the diagrams of the wire connector provided by the present invention. The wire connector (1) assembled by an insulating tube (2) and a soldering sleeve (3) is for connecting a plurality of conducting wires (41) which are made of conducting cores (42) and insulating claddings (43) surrounding the conducting cores. Wherein, the insulating tube (2) is shrinking to deform when heated to the first temperature, and its melting point is at the second temperature. The soldering sleeve (3) with corrugated surface (32) of its external part (31) (as shown in FIG. 3) is placed in the insulating tube (2) and its melting point is the third temperature which is between the first temperature and the second temperature.

The method to fabricate the wire connector is to heat the external part (21) of the insulating tube (2) where corresponding to the soldering sleeve (2) by the temperature between the first temperature and the third temperature, and the insulating tube (2) will shrink due to its substantial properties, therefore the internal part (22) of the insulating tube (2) will lodge into the corrugated surface (32) of the soldering sleeve (3).

Referring to FIG. 3, the soldering sleeve (3) placed in the insulating tube (2) is for fabricating a wire connector (1). The melting point of it is the third temperature which is between the first temperature and the second temperature. It would be made to be corrugated on its external surface (31) (as shown in FIG. 3A), or to be corrugated both on outer surface (32) and inner surface (33) (as shown in FIG. 3B). Moreover, the soldering sleeve (3) could also be wound by a soldering wire (5), placed in the insulating tube (2), and corrugated on its external surface (52), or to be corrugated both on outer surface (52) and inner surface (53)(as shown in FIG. 3C). Every above-mentioned embodiment of the soldering sleeve (3) would have the interference with the insulating tube (2) and be more immovable.

Consequently, the wire connector made by this kind of method is better than the prior art by combination strength.

The corrugated surface (32,33,52,53) of the soldering sleeve (3) is wavy. The waveform could be of the same height or of different heights, and could be of the same pitch or of different pitches. Also, the corrugated surface (32,33,52,53) of the soldering sleeve (3) is serrate, The serration could be of the same height or of different heights, and could be of the same pitch or of different pitches. No matter what kind of the soldering sleeve (3) is, the material of it is selected from the group consisting of the tin, lead, nickel, gold, silver, copper, bismuth, and the combinations.

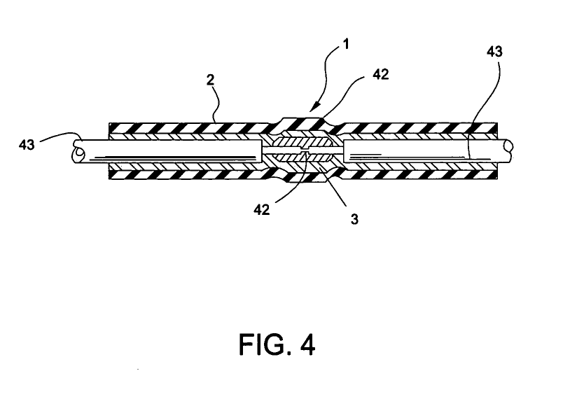

As shown in FIG. 4, in the use and operation of the invention, the procedure of connecting two wires comprises the following steps:

1) providing the conducting cores (42) stuck out of the wires (41);
2) inserting the wires (41) into the ends of the wire connector (1);
3) providing the tops of the conducting cores (42) contacting with each other in the soldering sleeve (3); and
4) heating the insulating tube (2) until the temperature reaches to the third temperature.

Then, the soldering sleeve (3) will be melted to combine with the conducting core (42), and the insulating tube (2) will shrink and stick the insulating claddings (43) of the wires (41). So that, the wire connector connects the wires tightly and strictly.

It should be noted that the above-described and illustrated embodiments of the invention are not an exhaustive listing of the forms such a wire connector in accordance with the invention might take; rather, they serve as exemplary and illustrative of embodiments of the invention as presently understood. By way of example, and without limitation, many other forms of the invention are believed to exist.

What is claimed is:

1. A wire connector for connecting a plurality of conducting wires which are made of conducting cores and insulating claddings surrounding the conducting cores, comprising:
an insulating tube which is shrinking to deform when heated to the first temperature, with the melting point at the second temperature; and
a soldering sleeve which is placed in the insulating tube, with the melting point at the third temperature which is between the first temperature and the second temperature, having a corrugated surface of its external part;
whereby, when heating the external part of the insulating tube where corresponding to the soldering sleeve by the temperature between the first temperature and the third temperature, the insulating tube shrinking to lodge the corrugated surface of the soldering sleeve, and the wire connector assembled.

2. The wire connector according to claim 1, wherein the corrugated surface of the soldering sleeve is wavy, and the waveform is of the same height or of different heights.

3. The wire connector according to claim 2, wherein the waveform is of the same pitch or different pitches.

4. The wire connector according to claim 1, wherein the corrugated surface of the soldering sleeve is serrate, and the serration is of the same height or of different heights.

5. The wire connector according to claim 4, wherein the serration is of the same pitch or of different pitches.

6. The wire connector according to claim 1, wherein the material of the soldering sleeve is selected from the group consisting of the tin, lead, nickel, gold, silver, copper, bismuth, and the combinations.

7. A wire connector for connecting a plurality of conducting wires which are made of conducting cores and insulating claddings surrounding the conducting cores, comprising:
an insulating tube which is shrinking to deform when heated to the first temperature, with the melting point at the second temperature;
a soldering sleeve which is wound by a soldering wire and placed in the insulating tube, with the melting point at the third temperature which is between the first temperature and the second temperature, having a corrugated surface of its external part; and
whereby, when heating the external part of the insulating tube where corresponding to the soldering sleeve by the temperature between the first temperature and the third temperature, the insulating tube shrinking to lodge the corrugated surface of the soldering sleeve, and the wire connector assembled.

8. The wire connector according to claim 7, wherein the soldering sleeve further having a corrugated inner surface.

9. The wire connector according to claim 7, wherein the material of the soldering sleeve is selected from the group consisting of the tin, lead, nickel, gold, silver, copper, bismuth, and the combinations.

10. A method of fabricating the wire connector for connecting a plurality of conducting wires made of conducting cores and insulating claddings surrounding the conducting cores, comprising:
providing an insulating tube which is shrinking to deform when heated to the first temperature and with the melting point at the second temperature;
providing a soldering sleeve placed in the insulating tube, with the melting point at the third temperature which is between the first temperature and the second temperature, and having a corrugated surface of its external part; and
heating the external part of the insulating tube where corresponding to the soldering sleeve by the temperature between the first temperature and the third temperature, the insulating tube shrinking to lodge the corrugated surface of the soldering sleeve, and the wire connector assembled.

11. The method according claim 10, wherein the soldering sleeve further having a corrugated inner surface.

12. A method of fabricating the wire connector for connecting a plurality of conducting wires made of conducting cores and insulating claddings surrounding the conducting cores, comprising:
providing an insulating tube which is shrinking to deform when heated to the first temperature and with the melting point at the second temperature;
providing a soldering sleeve which is wound by a soldering wire and placed in the insulating tube, with the melting point at the third temperature which is between the first temperature and the second temperature, and having a corrugated surface of its external part; and
heating the external part of the insulating tube where corresponding to the soldering sleeve by the temperature between the first temperature and the third temperature, the insulating tube shrinking to lodge the corrugated surface of the soldering sleeve, and the wire connector assembled.

13. A soldering sleeve for being placed in the insulating tube to fabricate a wire connector, the insulating tube which is shrinking to deform when heated to the first temperature and with the melting point at the second temperature; the improvement comprising:
the soldering sleeve with the melting point at the third temperature which is between the first temperature and the second temperature, having a corrugated surface of its external part.

14. The soldering sleeve according to claim 13, wherein the corrugated surface is wavy, and the waveform is of the same height or of different heights.

15. The soldering sleeve according to claim 14, wherein the waveform is of the same pitch or of different pitches.

16. The soldering sleeve according to claim 13, wherein the corrugated surface is serrate, and the serration is of the same height or of different heights.

17. The soldering sleeve according to claim 16, wherein the serration is of the same pitch or of different pitches.

18. The soldering sleeve according to claim 13, wherein the material of the soldering sleeve is selected from the group consisting of the tin, lead, nickel, gold, silver, copper, bismuth, and the combinations.

19. A soldering sleeve for being placed in the insulating tube to fabricate a wire connector, the insulating tube which is shrinking to deform when heated to the first temperature and with the melting point at the second temperature; the improvement comprising:
the soldering sleeve which is wound by a soldering wire and placed in the insulating tube, with the melting point at the third temperature which is between the first temperature and the second temperature, having a corrugated surface of its external part.
